(19) United States
(12) Patent Application Publication
(10) Pub. No.: US 2022/0161241 A1
(43) Pub. Date: May 26, 2022

(54) ZEOLITE CATALYST FOR HYDROCARBON OXIDATION AND METHOD FOR MANUFACTURING THE SAME

(71) Applicants: HYUNDAI MOTOR COMPANY, Seoul (KR); KIA CORPORATION, Seoul (KR); INDUSTRY FOUNDATION OF CHONNAM NATIONAL UNIVERSITY, Gwangju (KR)

(72) Inventors: Dalyoung Yoon, Seongnam-si (KR); Soon Hee Park, Gwangju (KR); Sung June Cho, Gwangju (KR)

(21) Appl. No.: 17/404,020

(22) Filed: Aug. 17, 2021

(30) Foreign Application Priority Data
Nov. 20, 2020 (KR) 10-2020-0156425

(51) Int. Cl. B01J 29/74; B01J 29/54; B01J 37/30; B01J 37/04; B01J 37/06; B01J 37/08

(52) U.S. Cl. CPC B01J 29/743; B01J 29/54; B01J 29/7407; B01J 29/74; B01J 2229/18; B01J 37/04; B01J 37/06; B01J 37/082; B01J 2229/37; B01J 37/30

(57) ABSTRACT

A manufacturing method of a hydrocarbon oxidation catalyst and a catalyst therefrom, including preparing a positive ion type of zeolite, and supporting palladium (Pd) in the positive ion type of zeolite by an ion exchange method to obtain a palladium-supported zeolite, wherein an amount of the supported palladium is 0.5 to 5 wt % based on an entire weight of the hydrocarbon oxidation catalyst.

### CROSS REFERENCE TO RELATED APPLICATIONS

This application claims priority to and the benefit of Korean Patent Application No. 10-2020-0156425 filed in the Korean Intellectual Property Office on Nov. 20, 2020, the entire contents of which are incorporated herein by reference.

### BACKGROUND

### (a) Field

The present disclosure relates to a zeolite catalyst for oxidizing a hydrocarbon. More particularly, the present disclosure relates to a manufacturing method of a zeolite catalyst having high thermal durability and a zeolite catalyst manufactured thereby.

### (b) Description of the Related Art

Zeolite is a porous material with a unique and regular shape and size of fine pores. Acidity thereof may be widely controlled by varying an amount of aluminum present in the skeleton, and since a specific surface area is wide and positive ions may be exchanged, it is widely used as a catalyst or an adsorbent in a fine chemistry field.

Generally, an exhaust system of an engine includes post-processing devices such as a DOC (Diesel Oxidation Catalyst), a DPF (Diesel Particulate matter Filter), an SCR (Selective Catalyst Reduction) unit, and an LNT (Lean NOx Trap) for reducing carbon monoxide (CO), hydrocarbon (HC), particulate matter (PM), nitrogen oxide (NOx), and so on which are pollutant materials in exhaust gas.

Among them, the DOC plays a role of oxidizing hydrocarbons in the exhaust gas.

However, in the case of a saturated hydrocarbon, it is more difficult to oxidize because it is chemically stable compared to an unsaturated hydrocarbon, and particularly, the shorter the chain of the saturated hydrocarbon is, the more difficult it is to oxidize it.

In addition, in the case of the exhaust catalyst, it is necessary to ensure high heat resistance in which the performance of the zeolite catalyst is maintained even when it is exposed to the exhaust gas of a high temperature for application to actual vehicles. In other words, in order to apply a zeolite catalyst to the DOC, a zeolite catalyst has higher thermal durability and that maintains its performance even in a degraded state after use is required compared to a new product.

However, when aluminum present in the zeolite skeleton is exposed to water vapor of a high temperature, it elutes out of the skeleton and the structure of the zeolite collapses, resulting in lower catalyst activity. In addition, since various kinds of positive ions present in the zeolite also affect hydrothermal stability, controlling of the content of these components is a problem to be solved to increase the hydrothermal stability of the zeolite.

The above information disclosed in this Background section is only for enhancement of understanding of the background of the disclosure, and therefore it may contain information that does not form the prior art that is already known in this country to a person of ordinary skill in the art.

### SUMMARY

An object of the present disclosure is to provide a zeolite catalyst having high thermal durability by maintaining the zeolite structure even after degradation.

Another object of the present disclosure is to provide a zeolite catalyst that efficiently oxidizes saturated hydrocarbon while having excellent thermal durability.

A hydrocarbon oxidation catalyst according to an embodiment of the present disclosure includes a zeolite catalyst supported with palladium, wherein the palladium is supported at 0.5 to 5 wt % based on the entire weight of the supported zeolite catalyst. Preferably, palladium is supported in an amount of 1.5 to 2.5 wt % based on the entire weight of the supported zeolite catalyst.

The zeolite has a Si/Al ratio of 1 to 50.

The zeolite is one kind or more of a group consisting of AEI, AFX, ERI, LTA, and CHA zeolites.

In the hydrocarbon oxidation catalyst, an oxidation capacity performance degradation level is 30% or less even when the catalyst is degraded under a condition of 12 hours while flowing air containing 10% water at 100 ml/min to a catalyst layer heated to 850° C. to 950° C. (The performance degradation level is calculated by an equation (before deterioration−after deterioration)/(before deterioration)*100 (%))

A manufacturing method of a hydrocarbon oxidation catalyst according to an embodiment of the present disclosure includes preparing a positive ion type of zeolite, and supporting palladium (Pd) in the positive ion type of zeolite by an ion exchange method to obtain a palladium-supported zeolite, wherein an amount of the supported palladium is 0.5 to 5 wt % based on an entire weight of the hydrocarbon oxidation catalyst.

The positive ion type of zeolite has a Si/Al ratio of 1 to 50.

The positive ion type of zeolite is one or more of a group consisting of AEI, AFX, ERI, LTA, and CHA positive ion types of zeolites,

In the preparing of the positive ion type of zeolite, the positive ion type of zeolite is an NH₄ type of zeolite, and the preparing of the NH₄ type of zeolite includes preparing a zeolite source material, refluxing the zeolite source material into ammonium, and obtaining an NH₄ type of zeolite including an NH₄⁺ ion through washing and drying after the refluxing.

In the preparing of the positive ion type of zeolite, the positive ion type of zeolite is an H type of zeolite, the preparing of the H type of zeolite includes preparing a zeolite source material, refluxing the zeolite source material into ammonium, obtaining an NH₄ type of zeolite including an NH₄⁺ ion through washing and drying after the refluxing, and calcining the obtained NH₄ type of zeolite at 500 to 700° C. for 5 to 10 hours to obtain an H zeolite.

The supporting of the palladium (Pd) into the positive ion type of zeolite by an ion exchange method includes mixing zeolite in the palladium precursor solution, increasing a temperature of the mixed solution to perform ion exchange, washing and drying, calcining, and H₂-treating, wherein the palladium precursor solution is one or more selected from a group including palladium acetate monohydrate, palladium nitride, palladium nitrate, and palladium sulfate.

The increasing of the temperature of the mixed solution to perform the ion exchange is performed at a temperature of 25° C. to 80° C. for 1 hour to 24 hours.

The washing and drying is performed at a temperature of 50 to 100° C. for 6 to 18 hours.

The calcination is performed for 1 to 24 hours at a temperature of 400 to 750° C. in an air atmosphere.

The H₂ treatment is performed for 1 hour to 5 hours at a temperature of 200 to 500° C. in an H₂ atmosphere.

The zeolite catalyst according to the present disclosure improves low temperature oxidation performance of the saturated hydrocarbon.

The zeolite catalyst according to the present disclosure has improved heat resistance, thereby the catalyst performance is maintained even if it is degraded by being exposed to an exhaust gas of a high temperature.

### BRIEF DESCRIPTION OF THE FIGURES

FIG. 1 is a graph for evaluating a methane oxidation capacity of an experimental example in the present disclosure.

FIG. 2 is a graph for evaluating an ethane oxidation ability of an experimental example in the present disclosure.

FIG. 3 is a graph for evaluating a pentane oxidation ability of an experimental example in the present disclosure.

### DETAILED DESCRIPTION

Advantages and features of the technology to be described later, and a method for achieving them, will become apparent with reference to embodiments described later in detail together with accompanying drawings. However, implemented forms may not be limited to the embodiments disclosed below. Although not specifically defined, all terms including technical and scientific terms used herein have meanings understood by ordinary persons skilled in the art. The terms have specific meanings coinciding with related technical references and the present specification as well as lexical meanings. That is, the terms are not construed as having ideal or formal meanings.

Throughout this specification, unless explicitly described to the contrary, the word “comprise”, and variations such as “comprises” or “comprising”, will be understood to imply the inclusion of stated elements but not the exclusion of any other elements.

In addition, the terms of a singular form may include plural forms unless referred to the contrary.

The manufacturing method of a hydrocarbon oxidation catalyst according to an embodiment of the present disclosure includes preparing a positive ion type of zeolite; and supporting palladium (Pd) in the zeolite by an ion exchange method.

The positive ion type of zeolite may be a NH₄ type or H type of zeolite.

The preparing of the NH₄ type of zeolite includes preparing a zeolite source material, refluxing the zeolite source material in an ammonium salt, and washing and drying the zeolite source material after the refluxing to obtain an NH₄ type of zeolite containing NH₄⁺ ions. At this time, the ammonium salt is not limited as long as it may be dissociated into NH₄⁺ ions, and for example, may be an ammonium nitrate (NH₄NO₃). The refluxing may be performed by immersing zeolite in an ammonium aqueous solution and stirring the zeolite for 5 to 7 hours at a temperature of 60 to 100° C.

The zeolite source material refers to zeolite to which metal positive ions obtained during the zeolite manufacturing process are attached, and may be, for example, Na-zeolite. That is, it is a zeolite that is not substituted with H or NH₄ positive ions.

The H type of zeolite may be obtained by firing the NH₄ type of zeolite obtained by the above-method at 500 to 700° C. for 5 to 10 hours.

At this time, the zeolite used to prepare the positive ion type of zeolite may have a Si/Al ratio of 1 to 50. Preferably, the Si/Al ratio may be 5 to 26. More preferably, the Si/Al ratio may be 9 to 15.

In addition, the used zeolite may be one or more kind of a group consisting of AEI, AFX, EM, LTA, and CHA zeolites. Preferably, it may be one or more in the group consisting of AEI, AFX, and LTA zeolites. More preferably, it may be an AEI zeolite.

Next, the preparing of the Pd/zeolite catalyst by immersing palladium (Pd) in the positive ion type of zeolite by the ion exchange method is described. Specifically, an ion exchange method in which the positive ion type (H type or NH₄ type) of zeolite is added to a palladium precursor-containing solution to support the palladium metal in the zeolite may be used.

At this time, the amount of the supported palladium may be 0.5 to 5 wt %, preferably 1.5 to 2.5 wt %, based on the entire weight of the hydrocarbon oxidation catalyst. If the palladium supported amount is too small, such as less than 0.5 wt %, there may be a problem of deteriorated performance of the catalyst due to a decrease in the catalyst active point. If the palladium supported amount is too large, such as more than 5 wt %, there may be a problem that the catalyst performance is deteriorated due to a sintering phenomenon.

In the palladium ion exchange, the Pd/zeolite may be manufactured by mixing zeolite in the palladium precursor solution such as palladium acetate monohydrate, palladium nitride, palladium nitrate, or palladium sulfate, increasing a temperature of the mixture solution to execute ion exchange; washing and drying, and calcining and H₂ treating. The palladium precursor solution used at this time is preferably palladium nitrate.

The performing of the ion exchange by increasing the temperature of the mixed solution may be performed for 1 hour to 24 hours at 25° C. to 80° C. depending on the amount of ions to be exchanged. Specifically, it may be performed at 75 to 85° C. for 23 to 25 hours.

The washing and drying may be carried out for 6 to 18 hours at a temperature of 50 to 100° C. Specifically, it may be washed for 10 to 14 hours at a temperature of 55 to 65° C. and then dried.

After washing and drying, the calcining is performed. The calcination may be performed for 1 to 24 hours at a temperature of 400 to 750° C. in an air atmosphere. Preferably, the temperature of the calcination may be 500 to 600° C. and the time may be 1 to 3 hours.

After the calcination, the H2 treatment is performed. The treatment is carried out for 1 to 5 hours at a temperature of 200 to 500° C. in an H2 atmosphere. It is preferably carried out for 1 to 3 hours at a temperature of 350 to 450° C.

After passing through the H₂ treatment, a zeolite catalyst supported with palladium is obtained.

Meanwhile, the prepared zeolite catalyst may be hydrothermal-treated for a hydrothermal stability test. The hydrothermal treatment may occur for 12 hours while flowing air containing water at 10% at 100 ml/min to the catalyst layer heated at 850° C. to 950° C.

The zeolite catalyst according to another embodiment of the present disclosure is manufactured by the above manufacturing method.

The hydrocarbon oxidation catalyst manufactured by the manufacturing method is a palladium-supported zeolite catalyst, and the palladium is supported at an amount of 0.5 to 5 wt % based on the entire weight of the supported zeolite catalyst. Preferably, the palladium may be supported at an amount of 1.5 to 2.5 wt %.

The zeolite may have a Si/Al ratio of 1 to 50. Preferably, the Si/Al ratio may be 5 to 26. More preferably, the Si/Al ratio may be 9 to 10.

The zeolite is one kind or more of the group consisting of AEI, AFX, EM, LTA, and CHA zeolites. Preferably, the zeolite may be one kind or more in the group consisting of AEI, AFX, and LTA zeolites. More preferably, the zeolite may be an AEI zeolite.

The hydrocarbon oxidation catalyst manufactured by the manufacturing method has excellent hydrocarbon resolution even after the degradation. That is, the hydrocarbon oxidation catalyst has an oxidation capacity performance degradation level of 30% even when the catalyst is degraded under a condition of 12 hours while flowing the air containing 10% water at 100 ml/min to the catalyst layer heated to 850° C. to 950° C. Preferably, the oxidation capacity performance degradation level may be 20% or less. The performance degradation level is calculated by an equation of (before deterioration−after deterioration)/(before deterioration)*100 (%).

Hereinafter, specific embodiments of the present disclosure are presented. However, the embodiments described below are only intended to specifically illustrate or describe the present disclosure, and this should not limit the scope of the present disclosure.

### MANUFACTURING EXAMPLE

### Manufacturing of Pd/Zeolite Catalyst

The Pd/zeolite was manufactured with the composition shown in Table 1 below.

The H type or NH₄ type of zeolite of each structure in Table 1 was added to a palladium nitrate aqueous solution with a palladium content adjusted to 1-3 wt %, ion-exchanged at 80° C. for 24 hours, and washed and dried. Subsequently, it was calcined in an air atmosphere at 550° C. for 2 hours and treated in an H2 atmosphere at 400° C. for 2 hours to prepare a zeolite (Pd/zeolite) catalyst in which palladium (Pd) was ion-exchanged.

TABLE 1

| Sample | Si/Al | Pd (wt %) |
|---|---|---|
| Pd/AEI zeolite | 9.7 | 1.5 |
| Pd/AFX zeolite | 6.3 | 2.4 |
| Pd/ERI zeolite | 5.1 | 2.2 |
| Pd/LTA zeolite | 25.3 | 2.2 |
| Pd/CHA zeolite | 11.8 | 2 |

### EXPERIMENTAL EXAMPLE

### Performance Evaluation of Palladium-Supported Zeolite (Pd/Zeolite) Catalyst

The saturated hydrocarbon oxidation capacity was evaluated by using a zeolite catalyst in which the manufactured palladium is ion-exchanged. The oxidation capacities of the non-deteriorated Pd/zeolite catalyst and the degraded Pd/zeolite catalyst were compared.

At this time, the degraded catalyst was prepared by hydrothermal treatment (for the deterioration) for 12 hours while flowing air containing 10% water in the prepared Pd/zeolite catalyst at 100 ml/min to the catalyst layer heated to 900° C.

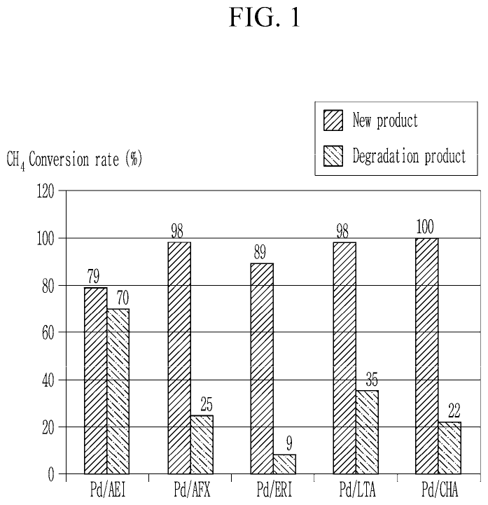

FIG. 1 to FIG. 3 are graphs comparing results of oxidation performance of a saturated hydrocarbon mixture gas before and after the degradation of the prepared Pd/zeolite catalyst. In other words, they are graphs comparing the amount oxidized in the catalyst before the degradation and the amount oxidized in the catalyst after the degradation for each of methane CH₄, ethane C₂H₆, and pentane C₅H₁₂ among the injected mixture gas.

0.1 g of the Pd/zeolite catalyst was used, the reaction was carried out by injecting the saturated hydrocarbon mixture gas into the pretreated catalyst layer, and a concentration of the gas (unreacted) exhausted to a gas chromatography (GC) device was analyzed. A conversion rate of each saturated hydrocarbon is calculated by an equation ((injected amount−unreacted amount)/injected amount)*100 (%). The reaction was measured by increasing the temperature with an interval of 25° C. starting at 200° C., and the pre-treatment and the reaction conditions are shown in Table 2 below. The gas composition is volume %.

TABLE 2

| | Pre-treatment condition | Reaction condition |
|---|---|---|
| Temperature (° C.) | 550 | 200 to 550 |
| Total flow rate (ml/min) | 200 | 200 |
| Space speed (h⁻¹) | 50,000 | 50,000 |
| HC (%) | — | 0.2 |
| CO (%) | 0.9 | 0.9 |
| H₂ (%) | 0.3 | 0.3 |
| O₂ (%) | 0.6 | 1.0 |
| H₂O (%) | 5 | 5 |
| N₂ (%) | Remainder | Remainder |

In Table 2, the space speed is a reciprocal of a contact time between the gas flowing to the catalyst and the catalyst in each condition. Among reaction conditions of Table 2, the temperature conditions are different according to each experiment condition to be described below. The composition of the saturated hydrocarbon mixture gas that may be charged when evaluating the catalyst performance is shown in Table 3 below. Table 3 shows the number of carbons in each hydrocarbon.

TABLE 3

| | Content (%) |
|---|---|
| Hydrocarbon | C1 reference |
| CH₄:saturated HC | 47 |
| C₂H₆:saturated HC | 10 |
| C₃H₆:unsaturated HC | 33 |
| C₅H₁₂:saturated HC | 10 |

### Experimental Example 1: Evaluation of Oxidation Capacity of Methane CH₄

The Pd/zeolite catalyst before the degradation and the degraded Pd/zeolite catalyst, each of which was completed until the pretreatment, were mounted in a catalyst reactor, and a saturated hydrocarbon mixture gas was charged as a reaction product to evaluate the oxidation capacity. The reaction was carried out in the range of 200 to 550° C., and the conversion rates of methane CH₄ measured at 475° C. were compared. Other reaction conditions are shown in Table 2.

Before and after the deterioration, the methane oxidation capacity of Pd/AEI, Pd/AFX, Pd/ERI, Pd/LTA, and Pd/CHA was evaluated, respectively, and a representative result of 475° C. is shown in FIG. 1 and Table 4.

TABLE 4

| | | | Performance |
|---|---|---|---|
| | CH₄ conversion ratio (%) | | degradation |
| | Before deterioration | After deterioration | level (%) |
| Pd/AEI | 79 | 70 | 11 |
| Pd/AFX | 98 | 25 | 74 |
| Pd/ERI | 89 | 9 | 90 |
| Pd/LTA | 98 | 35 | 64 |
| Pd/CHA | 100 | 22 | 78 |

In Table 4, the performance degradation level is calculated by an equation (before deterioration−after deterioration)/(before deterioration)*100 (%), and the conversion rate in Table 4 refers to the oxidized amount among the charged methane amount. As a result, when comparing only degradation products, Pd/AEI showed the most excellent performance, and the performance was lowered in order of Pd/LTA, Pd/AFX, Pd/CHA, and Pd/ERI. In addition, when comparing the performance degradation level of degradation products compared to new products, the performance degradation in the Pd/AEI catalyst was the lowest, and the performance degradation width was large in the order of Pd/LTA, Pd/AFX, Pd/CHA, and Pd/ERI. That is, it was found that the Pd/AEI zeolite had almost the same level of methane oxidation capacity as before the degradation even after the degradation.

### Experimental Example 2: Evaluation of an Oxidation Capacity of Ethane C₂H₆

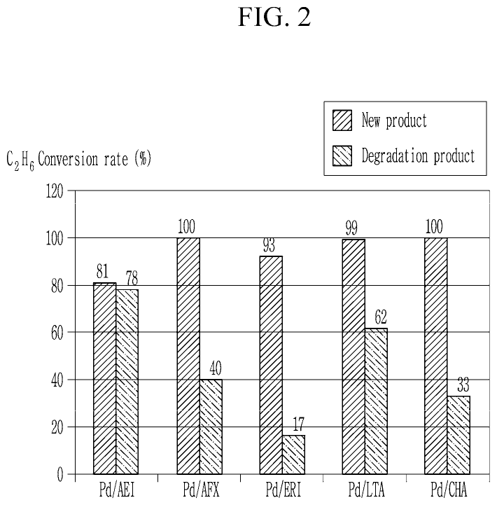

The Pd/zeolite catalyst before the degradation and the degraded Pd/zeolite catalyst, each of which was completed until the pretreatment, were mounted in a catalyst reactor, and a saturated hydrocarbon mixture gas was charged as a reaction product to evaluate the oxidation capacity. The reaction was carried out in the range of 200 to 550° C., and the conversion rates of ethane (C₂H₆) measured at 425° C. were compared. Before and after the deterioration, the ethane oxidation capacity of Pd/AEI, Pd/AFX, Pd/ERI, Pd/LTA, and Pd/CHA was evaluated, respectively, and a representative result at 425° C. is shown in FIG. 2 and Table 5.

TABLE 5

| | | | Performance |
|---|---|---|---|
| | C₂H₆ conversion rate (%) | | degradation |
| | Before deterioration | After deterioration | level (%) |
| Pd/AEI | 81 | 78 | 4 |
| Pd/AFX | 100 | 40 | 60 |
| Pd/ERI | 93 | 17 | 82 |
| Pd/LTA | 99 | 62 | 38 |
| Pd/CHA | 100 | 33 | 67 |

In Table 5, the performance degradation level was calculated by an equation (before deterioration−after deterioration)/(before deterioration)*100 (%), and the conversion rate in Table 5 refers to the oxidized amount among the charged ethane amount. As a result, when comparing only the degradation products, Pd/AEI showed the most excellent performance, and the performance decreased in the order of Pd/LTA, Pd/AFX, Pd/CHA, and Pd/ERI. In addition, when comparing the performance degradation level of degradation products compared to new products, the performance degradation in the Pd/AEI catalyst was the lowest, and the performance degradation width was larger in the order of Pd/LTA, Pd/AFX, Pd/CHA, and Pd/ERI. Like the case of methane, it was found that the Pd/AEI zeolite had almost the same level of the ethane oxidation capacity as before the degradation even after the degradation.

### Experimental Example 3: Evaluation of Oxidation Capacity of Pentane (C₅H₁₂)

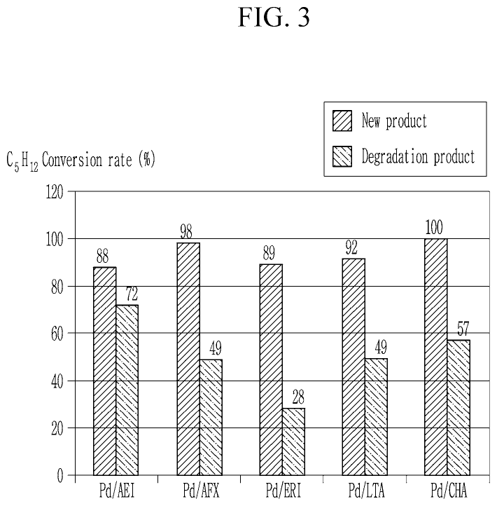

The Pd/zeolite catalyst before the degradation and the degraded Pd/zeolite catalyst, each of which was completed until the pretreatment, were mounted in a catalyst reactor, and a saturated hydrocarbon mixture gas was charged as a reaction product to evaluate the oxidation capacity. The reaction was performed in the range of 200 to 550° C., and the conversion rates of pentane (C5H12) measured at 350° C. were compared. Before and after the deterioration, the oxidation capacities of Pd/AEI, Pd/AFX, Pd/ERI, Pd/LTA, and Pd/CHA were evaluated, respectively, and a representative 350° C. result is shown in FIG. 3 and Table 6.

TABLE 6

| | | | Performance |
|---|---|---|---|
| | C₅H₁₂ conversion rate (%) | | degradation |
| | Before deterioration | After deterioration | level (%) |
| Pd/AEI | 88 | 72 | 18 |
| Pd/AFX | 98 | 49 | 50 |
| Pd/ERI | 89 | 28 | 68 |
| Pd/LTA | 92 | 49 | 46 |
| Pd/CHA | 100 | 57 | 43 |

In Table 6, the performance degradation level was calculated by an equation (before deterioration−after deterioration)/(before deterioration)*100 (%), and the conversion rate in Table 6 refers to the oxidized amount among the charged pentane amount. As a result, when comparing only the degradation products, Pd/AEI showed the most excellent performance, and the performance decreased in the order of Pd/CHA, Pd/LTA, Pd/AFX, and Pd/ERI. In addition, when comparing the performance degradation level of degradation products compared to new products, the performance degradation in the Pd/AEI catalyst was lowest, and the performance degradation width was larger in the order of Pd/CHA, Pd/LTA, Pd/AFX, and Pd/ERI. As in the case of methane and ethane, it was found that the Pd/AEI zeolite had almost the same level of the pentane oxidation capacity as before the degradation even after the degradation.

From the experiment results, it was found that the Pd/AEI zeolite catalyst had superior performance differences before and after the degradation compared to other zeolite catalysts.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

1. A hydrocarbon oxidation catalyst comprising:
a zeolite catalyst supported with palladium;
wherein the palladium is supported at 0.5 to 5 wt % based on the entire weight of the supported zeolite catalyst.

2. The hydrocarbon oxidation catalyst of claim 1, wherein the zeolite has a Si/A1 ratio of 1 to 50.

3. The hydrocarbon oxidation catalyst of claim 1, wherein the zeolite is one or more of a group consisting of: AEI, AFX, ERI, LTA, and CHA zeolites.

4. The hydrocarbon oxidation catalyst of claim 1, wherein the palladium is supported at 1.5 to 2.5 wt % based on the entire weight of the supported zeolite catalyst.

5. The hydrocarbon oxidation catalyst of claim 1, wherein in the hydrocarbon oxidation catalyst, an oxidation capacity performance degradation level is 30% or less when the catalyst is degraded under a condition for 12 hours while flowing air containing 10% water at 100 ml/min to a catalyst layer heated to 850° C. to 950° C.:
wherein the performance degradation level is calculated by an equation:
(before deterioration−after deterioration)/(before deterioration)*100%.

6. A manufacturing method of a hydrocarbon oxidation catalyst comprising:
preparing a positive ion type of zeolite; and
supporting palladium (Pd) in the positive ion type of zeolite by an ion exchange method to obtain a palladium-supported zeolite;
wherein an amount of the supported palladium is 0.5 to 5 wt % based on an entire weight of the hydrocarbon oxidation catalyst.

7. The manufacturing method of the hydrocarbon oxidation catalyst of claim 6, wherein the positive ion type of zeolite has a Si/Al ratio of 1 to 50.

8. The manufacturing method of the hydrocarbon oxidation catalyst of claim 6, wherein the positive ion type of zeolite is one or more of a group consisting of: AEI, AFX, ERI, LTA, and CHA positive ion types of zeolites.

9. The manufacturing method of the hydrocarbon oxidation catalyst of claim 6, wherein in the preparing of the positive ion type of zeolite, the positive ion type of zeolite is an NH₄ type of zeolite; and
the preparing of the NH₄ type of zeolite includes:
preparing a zeolite source material;
refluxing the zeolite source material into ammonium; and
obtaining an NH₄ type of zeolite including an NH₄⁺ ion through washing and drying after the refluxing.

10. The manufacturing method of the hydrocarbon oxidation catalyst of claim 6, wherein in the preparing of the positive ion type of zeolite, the positive ion type of zeolite is an H type of zeolite, and the preparing of the H type of zeolite includes:
preparing a zeolite source material;
refluxing the zeolite source material into ammonium;
obtaining an NH₄ type of zeolite including an NH₄⁺ ion through washing and drying after the refluxing; and
calcining the obtained NH₄ type of zeolite at 500 to 700° C. for 5 to 10 hours to obtain an H zeolite.

11. The manufacturing method of the hydrocarbon oxidation catalyst of claim 6, wherein the supporting of the palladium (Pd) into the positive ion type of zeolite by an ion exchange method includes:
mixing zeolite in the palladium precursor solution;
increasing a temperature of the mixed solution to perform ion exchange;
washing and drying;
calcining; and
H₂-treating;
wherein the palladium precursor solution is one or more selected from a group including palladium acetate monohydrate, palladium nitride, palladium nitrate, and palladium sulfate.

12. The manufacturing method of the hydrocarbon oxidation catalyst of claim 11, wherein the increasing of the temperature of the mixed solution to perform the ion exchange is performed at a temperature of 25° C. to 80° C. for 1 hour to 24 hours.

13. The manufacturing method of the hydrocarbon oxidation catalyst of claim 11, wherein the washing and drying is performed at a temperature of 50 to 100° C. for 6 to 18 hours.

14. The manufacturing method of the hydrocarbon oxidation catalyst of claim 11, wherein the calcination is performed for 1 to 24 hours at a temperature of 400 to 750° C. in an air atmosphere.

15. The manufacturing method of the hydrocarbon oxidation catalyst of claim 11, wherein the H₂ treatment is performed for 1 hour to 5 hours at a temperature 200 to 500° C. in an H₂ atmosphere.
